(19) United States
(12) Patent Application Publication
(10) Pub. No.: US 2011/0167883 A1
(43) Pub. Date: Jul. 14, 2011

(54) SIDE HUNG TYPE DOOR OR WINDOW HANDLE LOCK

(75) Inventor: Gongchun Zhang, Zengcheng City (CN)

(73) Assignee: CMECH (GUANGZHOU) INDUSTRIAL LTD., ZENGCHENG CITY (CN)

(21) Appl. No.: 12/752,229

(22) Filed: Apr. 1, 2010

(30) Foreign Application Priority Data
Jan. 11, 2010 (CN) 201020026398.3

(51) Int. Cl. E05B 65/06

(52) U.S. Cl. 70/89

(57) ABSTRACT

The present utility model discloses a side hung type door or window handle lock, comprising a first lock body and a second lock body mounted on inner and outer sides of the door or window and sandwiching the door or window in between, wherein the first lock body comprises a first handle, the second lock body comprises a second handle, in the first lock body is provided an inclined tongue locking and controlling mechanism connected to the first and second handles and controlled by them to open and close, and wherein the inclined tongue locking and controlling mechanism comprises a locking and controlling member and an inclined tongue member which are connected and linked to each other. The handle lock according to the present utility model exhibits a simple structure, a less number of parts, convenient assembling, convenient opening and closing operations, and higher safety performance and universal use.

### TECHNICAL FIELD

The present utility model relates to door or window handle locks in the technical field of door or window anti-theft locking apparatuses, and particularly to a side hung type door or window handle lock.

### BACKGROUND ART

In the prior art, there are various door or window locks with different effects. Conventional locks have an insert core lock body or a ball-shaped lock body which are relatively simple in structure and lower in cost and price. However, they both have their respective drawback, e.g., when the insert core lock body is installed, a door body structure must be damaged by opening a groove in a side end face of the door body to allow a lock tongue in and out, whereby the installing work is troublesome and time consuming and the strength of the door is damaged; the ball-shaped lock body damages the door body structure upon installation, and besides, has a single lock tongue and exhibits an undesirable safety performance. The prior-art side hung type door or window locks do not require damages to the door body structure upon installation, as in the Chinese patent ZL02225564.8 wherein the lock tongue is brought into rotation to lock the door by means of rotation and positioning of a handle, but such lock can be only used for opening and closing operation inside the window, and, moreover, the handle needs to be operated upon opening or closing so that the operations of such lock are inconvenient. Therefore, such lock is restrained to a very large extent in scope of use.

### SUMMARY OF THE INVENTION

An object of the present utility model is to overcome drawbacks and disadvantages in the prior art and provides a side hung type handle lock which is simple in structure, convenient in assembly, safe and reliable, and low in cost.

To achieve the above object, the present utility model is implemented by using the following technical solution:

A side hung type door or window handle lock, comprising a first lock body and a second lock body mounted on inner and outer sides of the door or window and sandwiching the door or window in between, characterized in that the first lock body comprises a first handle, the second lock body comprises a second handle, in the first lock body is provided an inclined tongue locking and controlling mechanism connected to the first and second handles and controlled by them to open and close, and in that the inclined tongue locking and controlling mechanism comprises a locking and controlling member and an inclined tongue member which are connected and linked to each other.

Furthermore, the locking and controlling member comprises: a rotation shaft running through a rotary member hereunder and connected to both the first handle and the second handle; a rotary member respectively connected and linked to the first handle and the second handle via the rotation shaft, and an upper interference protrusion and a lower interference protrusion are respectively provided on both sides of the rotary member, wherein the upper interference protrusion is brought in contact with and linked to the inclined tongue member; an elastic return member disposed on both sides of the lower interference protrusion of the rotary member to apply a force thereto to return.

Furthermore, the inclined tongue member comprises: an inclined tongue telescopically mounted in the first lock body and having an inclined-surface end portion extending out of the first lock body and an opposite end portion at which a bent leg is linked to the locking and controlling member; a third return spring which two ends respectively cooperate with the inclined tongue and a positioning piece by abutting against them.

Furthermore, in said first lock body is further disposed a cubic tongue locking and controlling mechanism.

Furthermore, the cubic tongue locking and controlling mechanism comprises: a cubic tongue that is embedded in the first lock body and is of a “ [symbol] ”-shaped configuration on both sides of which is respectively provided a profiled trough; a cubic tongue knob which one end extends out of the first lock body to form a turn button and which the other end is the cubic tongue knob end at which is provided a positioning turntable, the positioning turntable being provided with a dialing boss snap fitted into the above cubic tongue profiled trough and bringing the cubic tongue to extend and retract.

As compared with the prior art, the present utility model has the following advantageous effects:

1. The handle lock according to the present utility model exhibits a simple structure, a less number of parts, convenient assembling, convenient door-opening and closing operations, and higher safety performance;

2. The handle lock has a dual tongue locking and controlling mechanism including an inclined tongue plus a cubic tongue which provide safety and reliability.

3. The lock body is provided with openings on left and right sides thereof and is easy to assemble; the telescoping direction of the lock tongues can be conveniently changed so as to meet the requirements of side hung type doors or windows opened in different directions such as inward, outward, leftward, and rightward; the handle lock can be universally utilized with a less cost.

### BRIEF DESCRIPTION OF THE ACCOMPANYING DRAWINGS

FIG. 1 is a schematic view showing the structure of the present utility model;

FIG. 2 is an exploded view of the structure as shown in FIG. 1;

FIG. 3 is a schematic view showing interior structure of a left side hung type first lock body;

FIG. 4 is a schematic view showing interior structure of a right side hung type first lock body;

FIG. 5 is a schematic view showing a cubic tongue locking and controlling mechanism;

FIG. 6 is a schematic view showing the structure of the cubic tongue of FIG. 5;

FIG. 7 is a schematic view showing the structure of the cubic tongue knob of FIG. 5; and

FIG. 8 is a schematic view showing the structure of the cubic tongue knob and a positioning resilient piece of FIG. 5.

### DETAILED DESCRIPTION OF PREFERRED EMBODIMENTS

To be more clearly understood, the present utility model will be further described with reference to the accompanying drawings but is not limited to the embodiments.

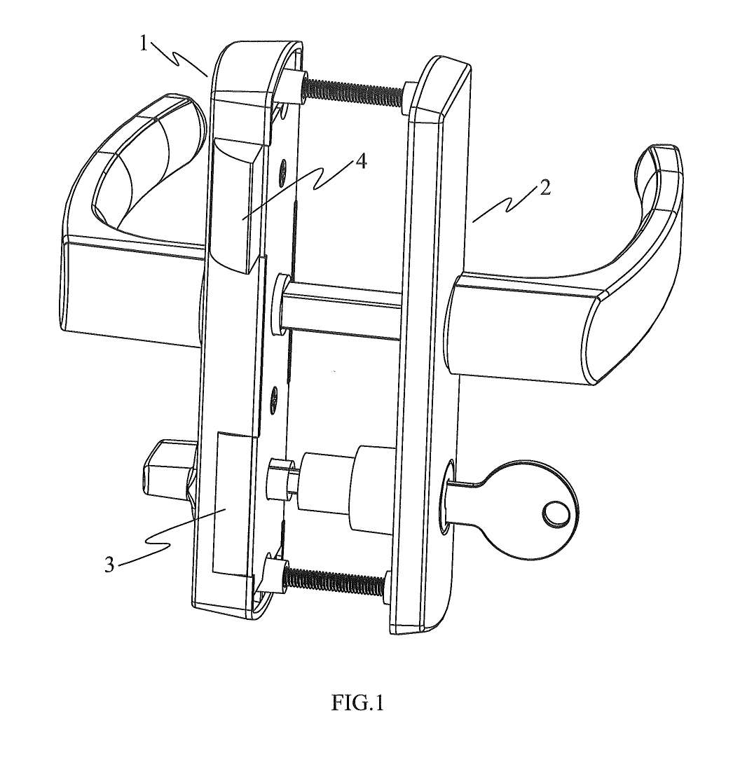

As shown in FIG. 1, the side hung type door or window handle lock according to the present utility model is a left side hung type door or window handle lock, comprising a first lock body 1 and a second lock body 2 mounted on inner and outer sides of the door or window and sandwiching the door or window in between, wherein the first lock body 1 comprises a first handle 11, the second lock body comprises a second handle 21, and wherein a cubic tongue locking and controlling mechanism 3 and an inclined tongue locking and controlling mechanism 4 are provided in the first lock body 1. In the present embodiment, the first lock body 1 is mounted inside the door and the second lock body 2 is mounted outside the door.

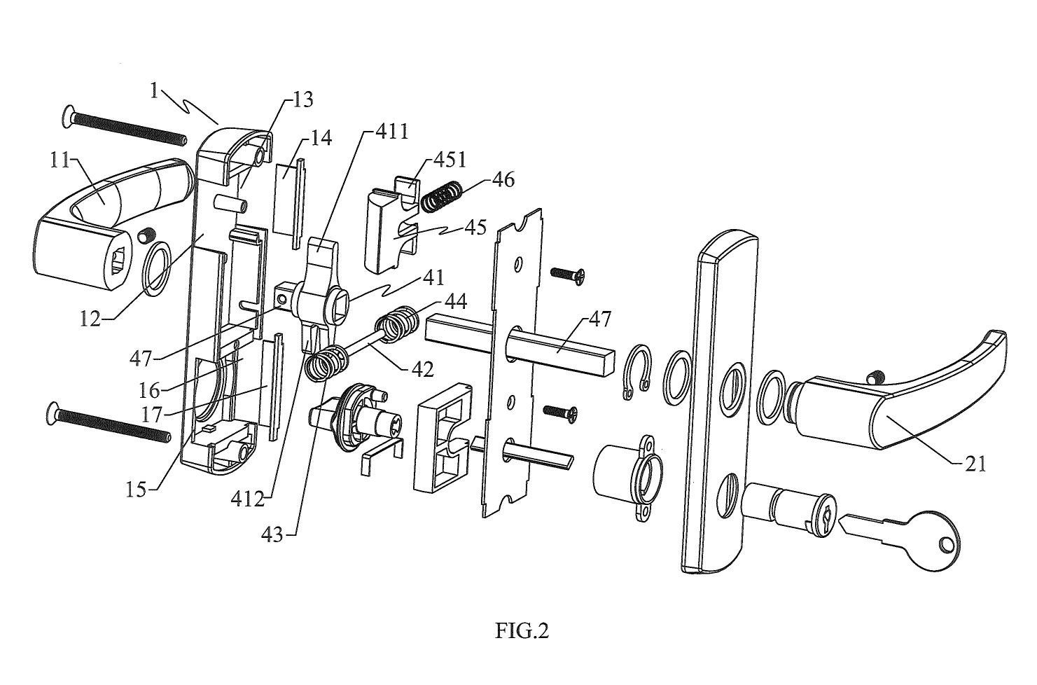

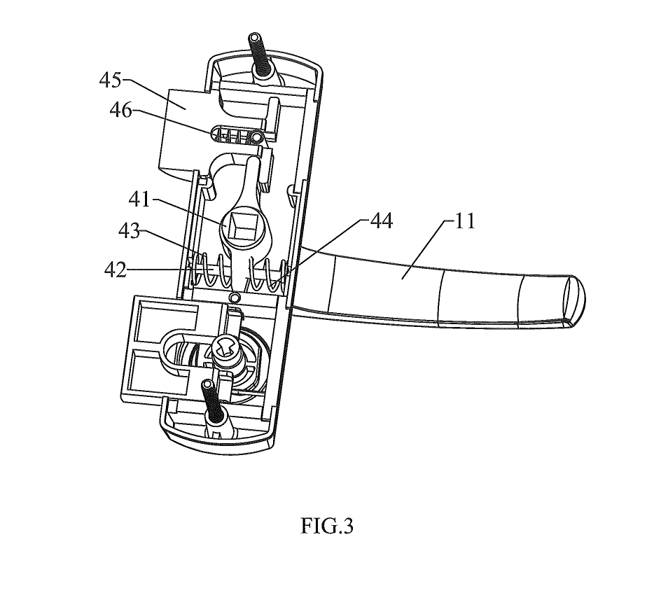

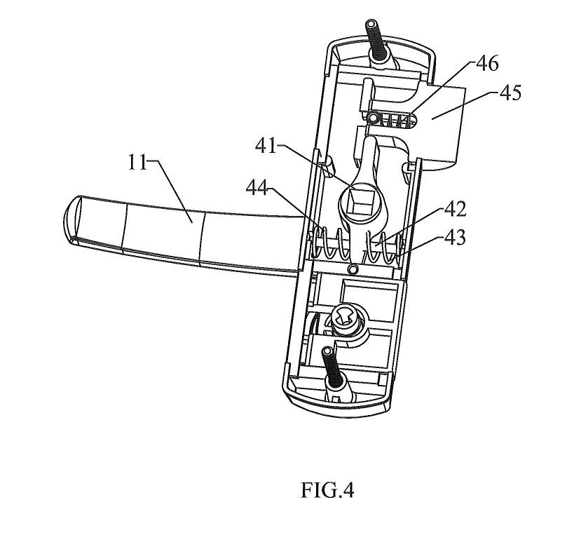

As shown in FIGS. 2-4, the inclined tongue controlling and controlling mechanism 4 comprises a locking and controlling member and an inclined tongue member which are connected and linked to each other, wherein the locking and controlling member comprises: a rotary member 41 respectively connected and linked to the first handle 11 and the second handle 21, and an upper interference protrusion 411 and a lower interference protrusion 412 are respectively provided symmetrically on the same line on both sides of the rotary member 41, and a notch is provided on the lower interference protrusion 412; a guide shaft 42 transversely disposed in the notch of the lower interference protrusion 412 and slidingly contacting and mating with the rotary member 41; an elastic member comprising a first return spring 42 and a second return spring 44 which are both provided around the guide shaft 42 and located on both sides of the lower interference protrusion 412. The inclined tongue member comprises: an inclined tongue 45 which is embedded in the first lock body and which has an inclined-surface end portion extending out of the first lock body 1 and an opposite end portion at which a bent leg 451 is linked to the upper interference protrusion 411 of the rotary member; a third return spring 46 which two ends respectively cooperate with the inclined tongue 45 and a threaded hole positioning piece by abutting against them.

Furthermore, at a left side and a right side of the upper portion of the first lock body 1 are respectively symmetrically provided a left inclined tongue opening 12 and a right inclined tongue opening 13 for allowing the inclined tongue to extend out. For a left side hung type handle lock, the left inclined tongue opening 12 is used for mounting the inclined tongue 45, and an inclined tongue baffle 14 is movably mounted at the right inclined tongue opening 13 to cover the inclined tongue opening; for a right side hung type handle lock, the right inclined tongue opening 13 is used for mounting the inclined tongue 45, and the inclined tongue baffle 14 is movably mounted at the left inclined tongue opening 12 to cover the inclined tongue opening, whereby functional interchange between the left horizontal opening and right horizontal opening can be achieved by changing the direction and position of the inclined tongue.

In use, a user holds with a hand the first handle 11 or the second handle 21 and rotates it downwardly, the first handle 11 or the second handle 21 brings the rotary member 41 to rotate in the same direction via a square-cross sectional shaft 47, and during rotation of the rotary member 41, the upper interference protrusion 412 thereof compresses the first return spring 43 and the upper interference protrusion 411 brings the inclined tongue 45 to compress the third return spring 46 to retract inwardly; when the handle is released from the hand's holding, the inclined tongue 45 and the rotary member 41 return due to a return force of the first return spring 43 and the third return spring 46; if the first handle 11 or the second handle 21 rotates upwardly, it brings the rotary member 41 to rotate in the same direction via the square-cross sectional shaft 47, and during rotation of the rotary member 41, the lower interference protrusion 412 thereof compresses the second return spring 44 and the upper interference protrusion 411 breaks away from the inclined tongue 45 and the inclined tongue 45 does not work.

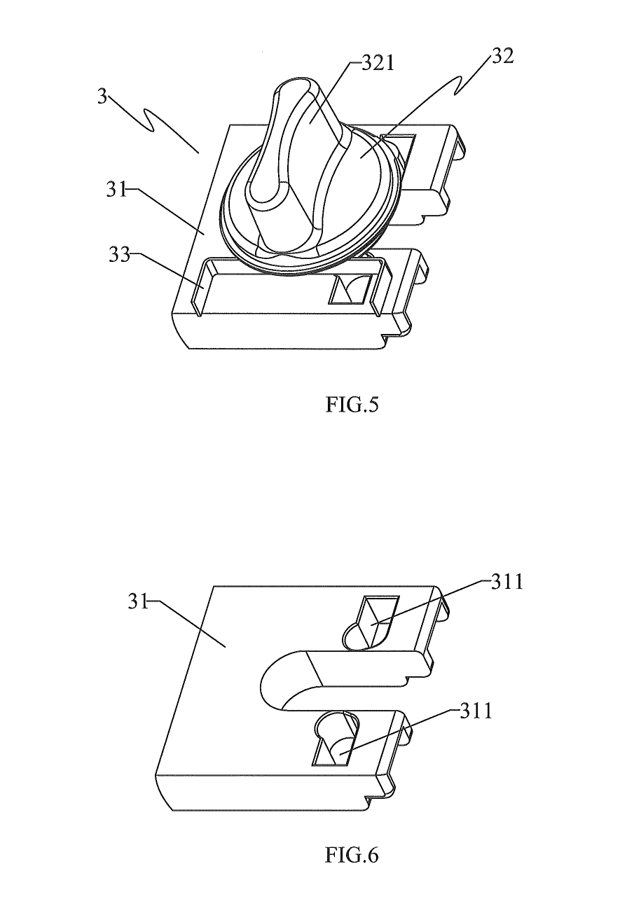

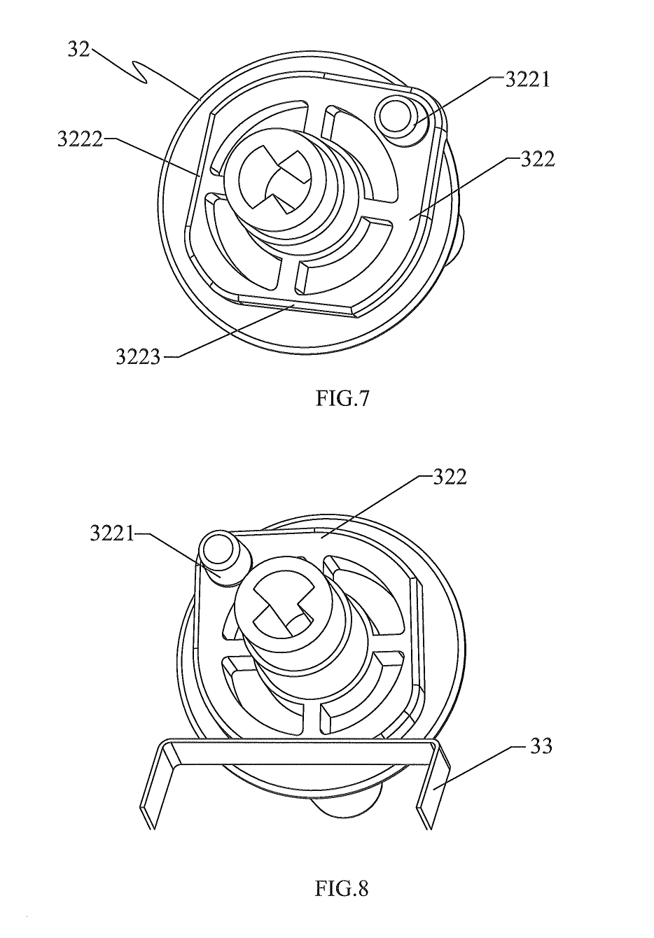

As shown in FIGS. 5-8, the above cubic tongue locking and controlling mechanism 3 comprises: a cubic tongue 31 that is embedded in the first lock body and is of a -shaped configuration on both sides of which is respectively provided a profiled trough; a cubic tongue knob 32 which is embedded in the first lock body and which turn button 321 extends out of the first lock body, wherein a positioning turntable 322 at the end of the cubic tongue knob opposite to the turn button 321, the positioning turntable 322 is provided with a dialing boss 3221 that is snap fitted into the profiled trough of the cubic tongue and brings the cubic tongue to extend or retract, a first straight edge 3222 and a second straight edge 3223 are provided on the sides opposite to the dialing boss 3221, and there is an arcuate smooth transition between the two straight edges; a positioning resilient piece 33 respectively abutting against and brought in contact with the first straight edge 3222 and the second straight edge 3223 of the positioning turntable 322 when the cubic tongue expends or retracts. Meanwhile, the second lock body is provided with a lock core connected to and cooperating with the cubic tongue knob, whereby the cubic tongue can be locked or unlocked with a special key from outside the door.

Furthermore, at a left side and a right side of the lower portion of the first lock body 1 are respectively symmetrically provided a left cubic tongue opening 15 and a right cubic tongue opening 16 for allowing the cubic tongue to extend out, as shown in FIGS. 2, 3 and 4. For a left side hung type handle lock, the left cubic tongue opening 15 is used for mounting the cubic tongue, and a cubic tongue baffle 17 is movably mounted at the right cubic tongue opening 16 to cover the cubic tongue opening; for a right side hung type handle lock, the right cubic tongue opening 16 is used for mounting the cubic tongue, and the cubic tongue baffle 17 is movably mounted at the left cubic tongue opening 15 to cover the cubic tongue opening, whereby functional interchange between the left horizontal opening and right horizontal opening can be achieved by changing the direction and position of the cubic tongue.

In use, a user holds with a hand the turn button 321 of the cubic tongue knob 32 and rotates it in the direction of extension of the cubic tongue 31, during rotation of the cubic knob 32, the dialing boss 3221 on the positioning turntable 322 brings the cubic tongue 31 to extend out outside gradually; when a contact surface of the positioning turntable 322 and the positioning resilient piece 33 switches from the first straight edge 3222 to the second straight edge 3223, the cubic tongue 31 extends out completely; the cubic tongue knob 32 can be quickly positioned due to the action of the positioning resilient piece 33, and meanwhile, due to the special shape of the profiled trough 311 the cubic tongue 31 cannot be made retract by an external force without destroying; the cubic tongue 31 can be allowed to retract quickly in the event of operation in an opposite direction; on the other hand, the cubic tongue can be locked or unlocked with a special key from outside the door.

The present utility model is not limited to the above embodiments. If various modifications or variations to the present utility model do not depart from the spirit and scope of the present utility model, and fall within the scope of claims of the present utility model and equivalent technologies, the present utility is intended to include such modifications or variations.

What is claimed is:

1. A side hung type door or window handle lock, comprising a first lock body and a second lock body mounted on inner and outer sides of the door or window and sandwiching the door or window in between, characterized in that the first lock body comprises a first handle, the second lock body comprises a second handle, in the first lock body is provided an inclined tongue locking and controlling mechanism connected to the first and second handles and controlled by them to open and close, and in that the inclined tongue locking and controlling mechanism comprises a locking and controlling member and an inclined tongue member which are connected and linked to each other.

2. The side hung type door or window handle lock according to claim 1, characterized in that the locking and controlling member comprises:
a rotation shaft running through a rotary member hereunder and connected to both the first handle and the second handle;
a rotary member respectively connected and linked to the first handle and the second handle via the rotation shaft, wherein an upper interference protrusion and a lower interference protrusion are respectively provided on both sides of the rotary member, and wherein the upper interference protrusion is brought in contact with and linked to the inclined tongue member;
an elastic return member disposed on both sides of the lower interference protrusion of the rotary member to apply a force thereto to return.

3. The side hung type door or window handle lock according to claim 2, characterized in that a notch is provided on the lower interference protrusion, a guide shaft transversely disposed in the notch of the lower interference protrusion and slidingly contacting and mating therewith; an elastic return member comprising a first return spring and a second return spring which are both provided around the guide shaft and located on both sides of the lower interference protrusion.

4. The side hung type door or window handle lock according to claim 2, characterized in that the inclined tongue member comprises:
an inclined tongue telescopically mounted in the first lock body and having an inclined-surface end portion extending out of the first lock body and an opposite end portion at which a bent leg is linked to the locking and controlling member;
a third return spring which two ends respectively cooperate with the inclined tongue and a positioning piece by abutting against them.

5. The side hung type door or window handle lock according to claim 4, characterized in that: on a left side and a right side of the first lock body are respectively symmetrically provided an inclined tongue opening for allowing the inclined tongue to extend out, and in that an inclined tongue baffle is movably mounted at one of inclined tongue openings to cover the inclined tongue opening.

6. The side hung type door or window handle lock according to claim 1, characterized in that: in said first lock body is further disposed a cubic tongue locking and controlling mechanism.

7. The side hung type door or window handle lock according to claim 6, characterized in that: the cubic tongue locking and controlling mechanism comprises:
a cubic tongue that is embedded in the first lock body and is of a “M”-shaped configuration on both sides of which is respectively provided a profiled trough;
a cubic tongue knob which one end extends out of the first lock body to form a turn button and which the other end is the cubic tongue knob end at which is provided a positioning turntable, the positioning turntable being provided with a dialing boss snap-fitted into said cubic tongue profiled trough and bringing the cubic tongue to extend and retract.

8. The side hung type door or window handle lock according to claim 7, characterized in that: a first straight edge and a second straight edge are provided on the sides opposite to the dialing boss, and there is an arcuate smooth transition between the two straight edges, the cubic tongue locking and controlling mechanism is provided a positioning resilient piece, and in that the first straight edge and the second straight edge of the positioning turntable respectively abut against and in contact with the positioning resilient piece when the cubic tongue expends or retracts.

9. The side hung type door or window handle lock according to claim 7, characterized in that: on a left side and a right side of the first lock body are respectively symmetrically provided a cubic tongue opening for allowing the cubic tongue to extend out, and in that a cubic tongue baffle is movably mounted at one of cubic tongue openings to cover the cubic tongue opening.

10. The side hung type door or window handle lock according to claim 7, characterized in that: the second lock body is provided with a lock core in connection with and cooperation with the cubic tongue knob.
